(19) United States
(12) Patent Application Publication
(10) Pub. No.: US 2018/0197211 A1
(43) Pub. Date: Jul. 12, 2018

(54) DYNAMICALLY GENERATING A PROMOTION AT A CHECKOUT

(71) Applicant: INTERNATIONAL BUSINESS MACHINES CORPORATION, ARMONK, NY (US)

(72) Inventor: Raghuveer P. Nagar, Kota (IN)

(21) Appl. No.: 15/400,099

(22) Filed: Jan. 6, 2017

(51) Int. Cl. G06Q 30/02

(52) U.S. Cl. CPC G06Q 30/0276; G06Q 30/0268; G06Q 30/0255

(57) ABSTRACT

An approach is provided for generating a promotion at a checkout. A purchase history of a customer who is purchasing item(s) at the checkout is retrieved. Based on the retrieved purchase history, the customer is determined to have made purchases of an item consistently over a time period prior to a time of the checkout. The item is determined to be not included in the item(s) being purchased at the checkout. It is determined that no promotion is currently available for a purchase of the item at the checkout and that promotion(s) were applied to the purchases of the item made by customer over the time period. Based on the aforementioned determinations, the promotion is dynamically generated at the checkout for a purchase of the item in a current transaction and/or future transaction(s). The promotion is generated for use by the customer and not any other customer.

### BACKGROUND

The present invention relates to managing a promotion of a product or service, and more particularly to dynamically generating a promotion for an item at a checkout.

Known techniques of generating real-time targeted advertising include using a purchase history of a consumer to generate a promotion for an item which is either an examined or purchased item. Other known techniques of targeted advertising present filler items which, if added to a consumer's cart, cause the consumer's order to be eligible for an active or ongoing promotion. Current approaches to a checkout-based distribution of promotions include distributing promotions based on transaction items, purchase history, demographics, customer lists, and customer coupon redemption history.

### SUMMARY

In one embodiment, the present invention provides a method of generating a promotion at a checkout. The method includes a computer retrieving a purchase history of a customer who is purchasing one or more items at the checkout in a current transaction. The method further includes based on the retrieved purchase history, the computer determining that the customer made purchases of an item consistently over a period of time prior to a time of the checkout. The method further includes in response to the step of determining that the customer made purchases of the item consistently over the period of time, the computer determining that the item is not included in the one or more items being purchased at the checkout. The method further includes the computer determining that no promotion is available for a purchase of the item at the time of the checkout. The method further includes the computer determining that one or more promotions were applied to the purchases of the item made by the customer over the period of time. The method further includes based on the purchases of the item having been made consistently by the customer over the period of time, the item not being included in the one or more items being purchased at the checkout, no promotion being available for the purchase of the item at the time of the checkout, and the one or more promotions having been applied to the purchases of the item made by the customer over the period of time, the computer dynamically generating the promotion at the checkout for a purchase of the item in the current transaction, future transaction(s), or the current transaction and future transaction(s). The promotion is generated at the checkout for use by the customer and not for use by any other customer.

In another embodiment, the present invention provides a computer program product including a computer-readable storage device and a computer-readable program code stored in the computer-readable storage device. The computer-readable program code includes instructions that are executed by a central processing unit (CPU) of a computer system to implement a method of generating a promotion at a checkout. The method includes a computer system retrieving a purchase history of a customer who is purchasing one or more items at the checkout in a current transaction. The method further includes based on the retrieved purchase history, the computer system determining that the customer made purchases of an item consistently over a period of time prior to a time of the checkout. The method further includes in response to the step of determining that the customer made purchases of the item consistently over the period of time, the computer system determining that the item is not included in the one or more items being purchased at the checkout. The method further includes the computer system determining that no promotion is available for a purchase of the item at the time of the checkout. The method further includes the computer system determining that one or more promotions were applied to the purchases of the item made by the customer over the period of time. The method further includes based on the purchases of the item having been made consistently by the customer over the period of time, the item not being included in the one or more items being purchased at the checkout, no promotion being available for the purchase of the item at the time of the checkout, and the one or more promotions having been applied to the purchases of the item made by the customer over the period of time, the computer system dynamically generating the promotion at the checkout for a purchase of the item in the current transaction, future transaction(s), or the current transaction and future transaction(s). The promotion is generated at the checkout for use by the customer and not for use by any other customer.

In another embodiment, the present invention provides a computer system including a central processing unit (CPU); a memory coupled to the CPU; and a computer-readable storage device coupled to the CPU. The storage device includes instructions that are executed by the CPU via the memory to implement a method of generating a promotion at a checkout. The method includes a computer system retrieving a purchase history of a customer who is purchasing one or more items at the checkout in a current transaction. The method further includes based on the retrieved purchase history, the computer system determining that the customer made purchases of an item consistently over a period of time prior to a time of the checkout. The method further includes in response to the step of determining that the customer made purchases of the item consistently over the period of time, the computer system determining that the item is not included in the one or more items being purchased at the checkout. The method further includes the computer system determining that no promotion is available for a purchase of the item at the time of the checkout. The method further includes the computer system determining that one or more promotions were applied to the purchases of the item made by the customer over the period of time. The method further includes based on the purchases of the item having been made consistently by the customer over the period of time, the item not being included in the one or more items being purchased at the checkout, no promotion being available for the purchase of the item at the time of the checkout, and the one or more promotions having been applied to the purchases of the item made by the customer over the period of time, the computer system dynamically generating the promotion at the checkout for a purchase of the item in the current transaction, future transaction(s), or the current transaction and future transaction(s). The promotion is generated at the checkout for use by the customer and not for use by any other customer.

Embodiments of the present invention provide a dynamic generation of a promotion based on an identification of items that are not being purchased in a current transaction, but had been repeatedly and consistently purchased in previous transactions, thereby assuring customer loyalty and increasing a sales value of the current transaction and/or future transaction(s).

### BRIEF DESCRIPTION OF THE DRAWINGS

FIG. 1 is a block diagram of a system for dynamically generating a promotion at a checkout, in accordance with embodiments of the present invention.

FIG. 2 is a flowchart of a process of dynamically generating a promotion at a checkout, where the process is implemented in the system of FIG. 1, in accordance with embodiments of the present invention.

FIG. 3 is a block diagram of a computer that is included in the system of FIG. 1 and that implements the process of FIG. 2, in accordance with embodiments of the present invention.

### DETAILED DESCRIPTION

### Overview

Embodiments of the present invention check a customer's purchase history at a checkout, determine that an item X is a product or service that the customer repeatedly and consistently purchased in the past, and determine that item X is missing from the customer's current order being processed at the checkout. Embodiments of the present invention determine that promotion(s) had been applied to the purchases of item X that the customer made consistently in the past and that no promotion is currently available for a purchase of item X at the checkout. Embodiments of the present invention determine that the customer has not included item X in the current order because no promotion for the purchase of item X is currently available. Embodiments of the present invention generate a promotion only for use by the customer so that the customer may purchase item X in the current order (e.g., by updating an online cart), in one or more future orders, or in both the current order and in one or more future orders using the generated promotion (e.g., purchase item X at a discounted price specified by the promotion). The promotion may be generated and distributed to the customer in any sales channel (e.g., physical retail store, web-based store, etc.).

In one example, customer C is a regular consumer of item X sold as brand A, and of all stores that customer C visits, a store S has been offering a discount on item X sold as brand A for a period of time (e.g., the last few months). Customer C has made multiple, regular visits to store S (e.g., once every week for the last few months) and buys multiple items on each visit, but the main purpose of the visits is to purchase item X under brand A with the discount. On the current day, customer C visits store S and begins to traverse store S, picking up multiple items that customer C wants to buy prior to reaching the portion of store S that includes item X. Upon reaching the portion of store S that includes item X, customer C discovers that there is no discount being offered today on item X. Customer C is disappointed, decides to buy the items that customer C had already picked up today, but decides to not buy item X because no discount on item X is available today. Customer C proceeds to initiate a checkout of the items already picked up, which does not include item X. Since customer C is now uncertain whether the discount on item X at store S will be available in the future, store S risks losing customer C as a regular customer, which presents a unique challenge to store S. Embodiments of the present invention overcomes the aforementioned challenge by determining the reason that customer C did not pick up item X for the current checkout (i.e., because the discount that had been available is not currently available to customer C) and based on the reason, dynamically generating a promotion for item X and providing the promotion to customer C during the current checkout. The promotion allows customer C to add item X to the order being processed in the current checkout and apply the discount to item X in the current checkout or to apply the discount to item X in a future checkout at store S. As a result of customer C receiving the promotion, store S maintains loyalty in customer C and either increases the amount of sales in the current checkout and/or increases an amount of future sales due to continued regular visits by customer C.

### System for Dynamically Generating a Promotion at a Checkout

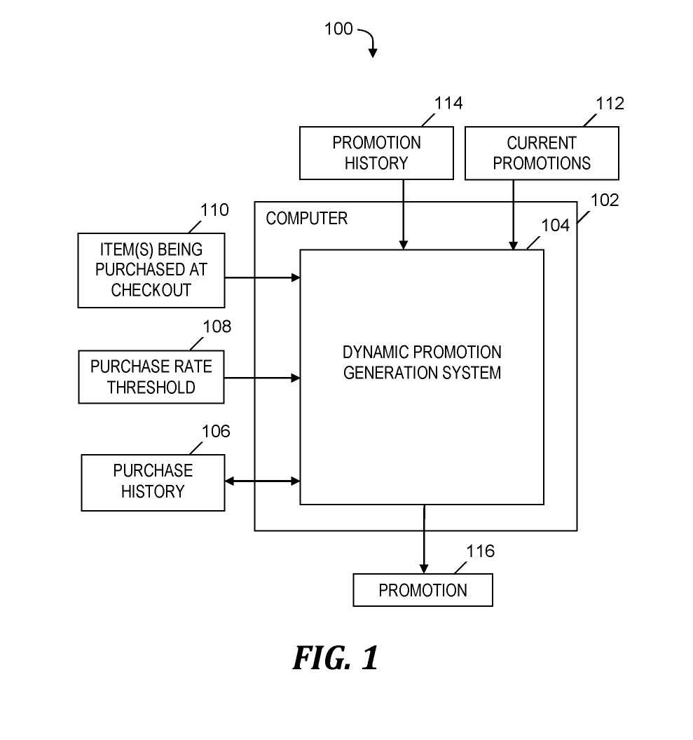

FIG. 1 is a block diagram of a system 100 for dynamically generating a promotion at a checkout, in accordance with embodiments of the present invention. System 100 includes a computer 102 which executes a software-based dynamic promotion generation system 104, which retrieves a purchase history 106 of a customer which specifies the customer's purchases of an item (i.e., a product or a service). Dynamic promotion generation system 104 receives a predetermined purchase rate threshold 108 (e.g., a purchase frequency threshold) for comparison to a purchase rate at which the customer made previous purchases of the item according to purchase history 106. The purchase rate may be based on a configurable number of orders and/or a configurable time period. For example, the purchase rate of item X may be based on item X being in P percent of the last Y orders of customer C. As another example, the purchase rate may be a frequency based on N orders that include item X being completed by customer C in a predetermined time period T.

Dynamic promotion generation system 104 receives an identification of item(s) 110 being purchased by the customer at a current checkout and determines that the aforementioned item is not included in item(s) 110. Dynamic promotion generation system 104 retrieves current promotions 112 to determine that no current promotion is available for a purchase of the item. Dynamic promotion generation system 104 retrieves information from promotion history 114 to determine that promotion(s) were applied to previous purchases of the item by the customer. Dynamic promotion generation system 104 dynamically generates a promotion 116 for the item at the current checkout, where the promotion is available to be used by the customer for a current purchase and/or a future purchase of the item, but cannot be used by any other customer.

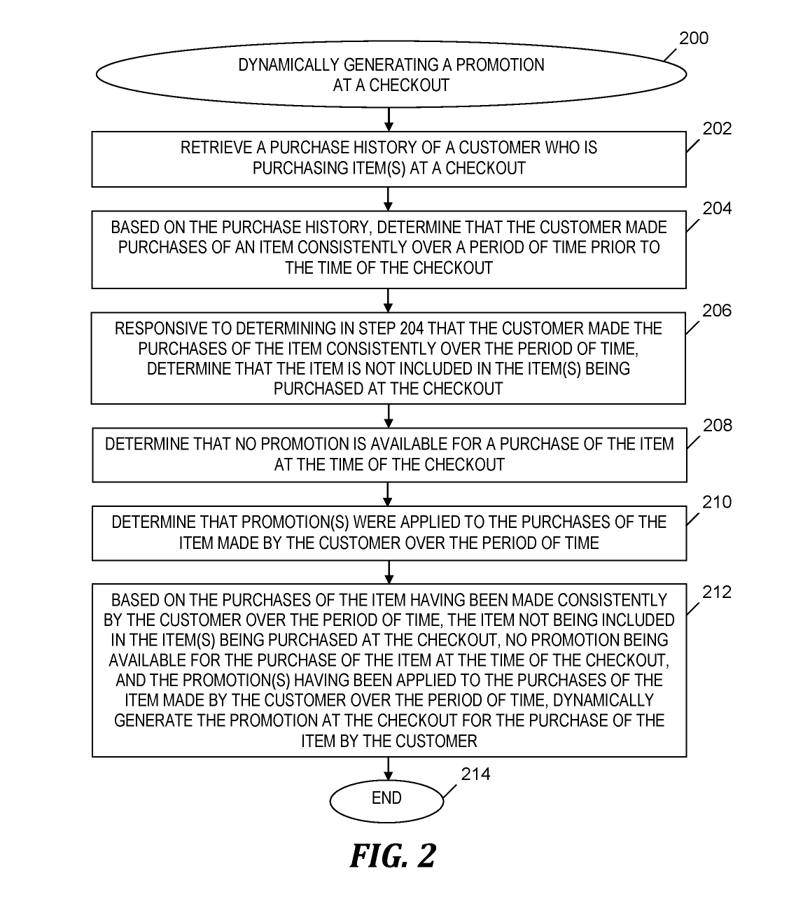

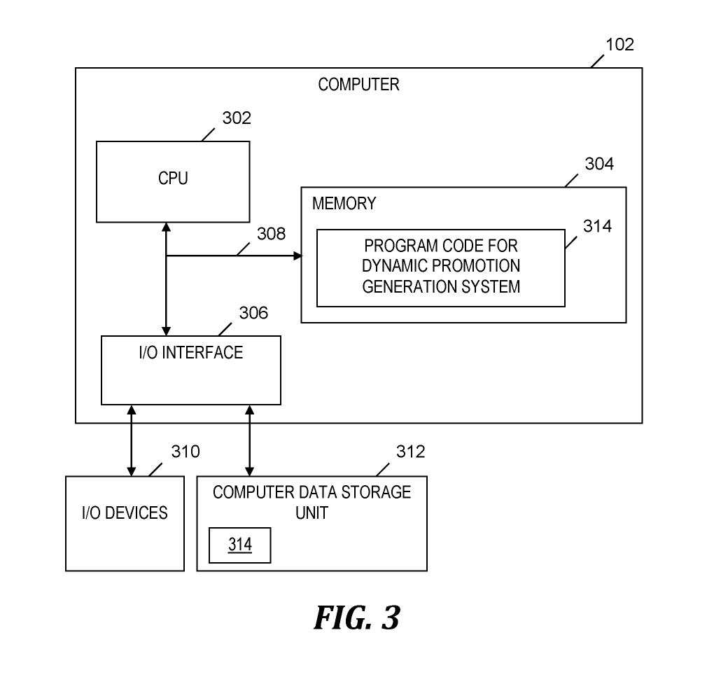

The functionality of the components shown in FIG. 1 is described in more detail in the discussion of FIG. 2 and FIG. 3 presented below.

### Process for Dynamically Generating a Promotion at a Checkout

FIG. 2 is a flowchart of a process of dynamically generating a promotion at a checkout, where the process is implemented in the system of FIG. 1, in accordance with embodiments of the present invention. The process of FIG. 2 begins at step 200 as a customer is engaged in a checkout and is purchasing item(s) 110 (see FIG. 1) at the checkout in a current transaction. In step 202, dynamic promotion generation system 104 (see FIG. 1) retrieves purchase history 106 (see FIG. 1) from a data repository included in or coupled to computer 102 (see FIG. 1). Purchase history 106 (see FIG. 1) includes a record of past purchases made by the customer, including what items were purchased and when the items were purchased.

Prior to step 204, dynamic promotion generation system 104 (see FIG. 1) receives purchase rate threshold 108 (see FIG. 1). In step 204, based on purchase history 106 (see FIG. 1) retrieved in step 202, dynamic promotion generation system 104 (see FIG. 1) determines that the customer made multiple purchases of an item consistently over a period of time prior to a start of the current transaction or prior to a time of the checkout. In one embodiment, the time of the checkout is a time of an initiation of the checkout (e.g., by a user activating a “checkout” button on a graphical user interface, which precedes entering shipping and payment information and precedes a confirmation of the order by which the item is being purchased). As used herein, making purchases of an item consistently is defined as purchasing the item multiple times at a purchase rate that exceeds a purchase rate threshold value (i.e., purchase rate threshold 108 (see FIG. 1)). In one embodiment, the purchase rate is a frequency of purchases of the item over a predetermined period of time. Hereinafter in the discussion of FIG. 2, the item that had been purchased consistently by the customer at a purchase rate that exceeds purchase rate threshold 108 (see FIG. 1) is referred to simply as “the item.”

Prior to step 206, dynamic promotion generation system 104 (see FIG. 1) receives an identification of item(s) 110 being purchased at the checkout. In step 206, responsive to the determination in step 204 that the customer made purchases of the item consistently over the period of time, dynamic promotion generation system 104 (see FIG. 1) determines that the item is not included in item(s) 110 (see FIG. 1) being purchased at the checkout.

In step 208, dynamic promotion generation system 104 (see FIG. 1) searches a data repository that includes current promotions 112 (see FIG. 1) and based on the search, determines that no promotion is available for a purchase of the item at the time of the checkout.

In step 210, dynamic promotion generation system 104 (see FIG. 1) searches a data repository that includes promotion history 114 (see FIG. 1) and based on the search, determines that promotion(s) were applied to the purchases of the item made by the customer over the period of time, which were determined in step 204.

In step 212, based on (i) the purchases of the item having been made consistently by the customer over the period of time (as determined in step 204), (ii) the item not being included in the item(s) 110 (see FIG. 1) being purchased at the checkout (as determined in step 206), (iii) no promotion being available for the purchase of the item at the time of the checkout (as determined in step 208), and (iv) the promotion(s) having been applied to the purchases of the item made by the customer over the period of time (as determined in step 210), dynamic promotion generation system 104 (see FIG. 1) dynamically generates a promotion at the checkout for a purchase of the item by the customer in the current transaction only, in future transaction(s) only, or in the current transaction and the future transaction(s). Dynamic promotion generation system 104 (see FIG. 1) dynamically generates the promotion in step 212 after the initiation of the checkout and prior to a confirmation of the order by which the customer is purchasing the item(s) 110 (see FIG. 1) being purchased at the checkout. Dynamic promotion generation system 104 (see FIG. 1) generates the promotion at the checkout in step 212 for use by the customer for a purchase of the item in the current and/or future transaction(s), but not for use by any other customer. After step 212, the process of FIG. 2 ends at step 214.

In one embodiment, after step 212 and prior to a confirmation of a current order by which the customer is purchasing item(s) 110 (see FIG. 1), dynamic promotion generation system 104 (see FIG. 1) receives an indication that the customer wants to use the dynamically generated promotion to purchase the item by adding the item to the current order. Dynamic promotion generation system 104 (see FIG. 1) adds the item to the current order prior to the confirmation of the current order.

In one embodiment, dynamic promotion generation system 104 (see FIG. 1) dynamically generates the promotion in step 212 as a discount on a price of the item and dynamic promotion generation system 104 (see FIG. 1) notifies the customer of an availability of the discount for a purchase of the item during the checkout or after a completion of the checkout.

In one or more embodiments, dynamic promotion generation system 104 (see FIG. 1) generates the promotion in step 212 by generating one or more types of promotions, which include, but are not limited to: (1) a discount on a price of the item based on a total monetary value of an order of the customer at the checkout exceeding a threshold value; (2) a discount on a price of the item, where the discount is permitted to be used within a predetermined period of time; (3) a discount on a price of the item, where the discount is permitted to be used exclusive of any other promotion relative to the item; (4) a discount on the price of the item if the customer purchases a predetermined item; and (5) a discount on the price of the item if the customer purchases an item of a predetermined type. The dynamic promotion generation system 104 (see FIG. 1) may determine a profit margin of the item and the step of generating the promotion in step 212 by the aforementioned combination of steps is based on the profit margin.

In one embodiment, dynamic promotion generation system 104 (see FIG. 1) presents the promotion generated in step 212 to the computing device of the customer during the checkout and prior to a confirmation of an order by which the customer is purchasing the item(s) 110 (see FIG. 1) and subsequently receives a selection made by the customer via the computing device for a purchase of the item, where the purchase uses the promotion during the checkout in which the item(s) 110 (see FIG. 1) are being purchased and prior to the confirmation of the order.

In one embodiment, dynamic promotion generation system 104 (see FIG. 1) presents the promotion generated in step 212 to the computing device of the customer and subsequently receives a selection made by the customer via the computing device for a purchase of the item, where the purchase uses the promotion in a transaction subsequent to a completion of the checkout (i.e., subsequent to a confirmation of an order by which the customer is purchasing the item(s) 110 (see FIG. 1)).

In an alternate embodiment, in place of step 208, dynamic promotion generation system 104 (see FIG. 1) sends an inquiry to a computing device of the customer, asking the customer to send a message that includes the customer's reason for the item not being included in the order by which item(s) 110 (see FIG. 1) are being purchased by the customer. In place of step 210, dynamic promotion generation system 104 receives the message from the customer's computing device and based on the reason included in the message, dynamic promotion generation system 104 (see FIG. 1) determines that the customer has not included the item in the order because no promotion for the purchase of the item is currently available to the customer.

### Computer System

FIG. 3 is a block diagram of a computer that is included in the system of FIG. 1 and that implements the process of FIG. 2, in accordance with embodiments of the present invention. Computer 102 is a computer system that generally includes a central processing unit (CPU) 302, a memory 304, an input/output (I/O) interface 306, and a bus 308. Further, computer 102 is coupled to I/O devices 310 and a computer data storage unit 312. CPU 302 performs computation and control functions of computer 102, including executing instructions included in program code 314 for dynamic promotion generation system 104 (see FIG. 1) to perform a method of dynamically generating a promotion at a checkout, where the instructions are executed by CPU 302 via memory 304. CPU 302 may include a single processing unit, or be distributed across one or more processing units in one or more locations (e.g., on a client and server).

Memory 304 includes a known computer readable storage medium, which is described below. In one embodiment, cache memory elements of memory 304 provide temporary storage of at least some program code (e.g., program code 314) in order to reduce the number of times code must be retrieved from bulk storage while instructions of the program code are executed. Moreover, similar to CPU 302, memory 304 may reside at a single physical location, including one or more types of data storage, or be distributed across a plurality of physical systems in various forms. Further, memory 304 can include data distributed across, for example, a local area network (LAN) or a wide area network (WAN).

I/O interface 306 includes any system for exchanging information to or from an external source. I/O devices 310 include any known type of external device, including a display device, keyboard, etc. Bus 308 provides a communication link between each of the components in computer 102, and may include any type of transmission link, including electrical, optical, wireless, etc.

I/O interface 306 also allows computer 102 to store information (e.g., data or program instructions such as program code 314) on and retrieve the information from computer data storage unit 312 or another computer data storage unit (not shown). Computer data storage unit 312 includes a known computer-readable storage medium, which is described below. In one embodiment, computer data storage unit 312 is a non-volatile data storage device, such as a magnetic disk drive (i.e., hard disk drive) or an optical disc drive (e.g., a CD-ROM drive which receives a CD-ROM disk).

Memory 304 and/or storage unit 312 may store computer program code 314 that includes instructions that are executed by CPU 302 via memory 304 to dynamically generate a promotion at a checkout. Although FIG. 3 depicts memory 304 as including program code, the present invention contemplates embodiments in which memory 304 does not include all of code 314 simultaneously, but instead at one time includes only a portion of code 314.

Further, memory 304 may include an operating system (not shown) and may include other systems not shown in FIG. 3.

Storage unit 312 and/or one or more other computer data storage units (not shown) that are coupled to computer 102 may store purchase history 106 (see FIG. 1), purchase rate threshold 108 (see FIG. 1), identifications of item(s) 110 (see FIG. 1) being purchased at the checkout, current promotions 112 (see FIG. 1), and promotion history 114 (see FIG. 1).

As will be appreciated by one skilled in the art, in a first embodiment, the present invention may be a method; in a second embodiment, the present invention may be a system; and in a third embodiment, the present invention may be a computer program product.

Any of the components of an embodiment of the present invention can be deployed, managed, serviced, etc. by a service provider that offers to deploy or integrate computing infrastructure with respect to dynamically generating a promotion at a checkout. Thus, an embodiment of the present invention discloses a process for supporting computer infrastructure, where the process includes providing at least one support service for at least one of integrating, hosting, maintaining and deploying computer-readable code (e.g., program code 314) in a computer system (e.g., computer 102) including one or more processors (e.g., CPU 302), wherein the processor(s) carry out instructions contained in the code causing the computer system to dynamically generate a promotion at a checkout. Another embodiment discloses a process for supporting computer infrastructure, where the process includes integrating computer-readable program code into a computer system including a processor. The step of integrating includes storing the program code in a computer-readable storage device of the computer system through use of the processor. The program code, upon being executed by the processor, implements a method of dynamically generating a promotion at a checkout.

While it is understood that program code 314 for dynamically generating a promotion at a checkout may be deployed by manually loading directly in client, server and proxy computers (not shown) via loading a computer-readable storage medium (e.g., computer data storage unit 312), program code 314 may also be automatically or semi-automatically deployed into computer 102 by sending program code 314 to a central server or a group of central servers. Program code 314 is then downloaded into client computers (e.g., computer 102) that will execute program code 314. Alternatively, program code 314 is sent directly to the client computer via e-mail. Program code 314 is then either detached to a directory on the client computer or loaded into a directory on the client computer by a button on the e-mail that executes a program that detaches program code 314 into a directory. Another alternative is to send program code 314 directly to a directory on the client computer hard drive. In a case in which there are proxy servers, the process selects the proxy server code, determines on which computers to place the proxy servers' code, transmits the proxy server code, and then installs the proxy server code on the proxy computer. Program code 314 is transmitted to the proxy server and then it is stored on the proxy server.

Another embodiment of the invention provides a method that performs the process steps on a subscription, advertising and/or fee basis. That is, a service provider, such as a Solution Integrator, can offer to create, maintain, support, etc. a process of dynamically generating a promotion at a checkout. In this case, the service provider can create, maintain, support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The present invention may be a system, a method, and/or a computer program product. The computer program product may include a computer readable storage medium (or media) (memory 304 and computer data storage unit 312) having computer readable program instructions 314 thereon for causing a processor (e.g., CPU 302) to carry out aspects of the present invention.

The computer readable storage medium can be a tangible device that can retain and store instructions (e.g., program code 314) for use by an instruction execution device (e.g., computer 102). The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions (e.g., program code 314) described herein can be downloaded to respective computing/processing devices (e.g., computer 102) from a computer readable storage medium or to an external computer or external storage device (e.g., computer data storage unit 312) via a network (not shown), for example, the Internet, a local area network, a wide area network and/or a wireless network. The network may comprise copper transmission cables, optical transmission fibers, wireless transmission, routers, firewalls, switches, gateway computers and/or edge servers. A network adapter card (not shown) or network interface (not shown) in each computing/processing device receives computer readable program instructions from the network and forwards the computer readable program instructions for storage in a computer readable storage medium within the respective computing/processing device.

Computer readable program instructions (e.g., program code 314) for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations (e.g., FIG. 2) and/or block diagrams (e.g., FIG. 1 and FIG. 3) of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions (e.g., program code 314).

These computer readable program instructions may be provided to a processor (e.g., CPU 302) of a general purpose computer, special purpose computer, or other programmable data processing apparatus (e.g., computer 102) to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium (e.g., computer data storage unit 312) that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions (e.g., program code 314) may also be loaded onto a computer (e.g. computer 102), other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of generating a promotion at a checkout, the method comprising the steps of:
a computer retrieving a purchase history of a customer who is purchasing one or more items at the checkout in a current transaction;
based on the retrieved purchase history, the computer determining that the customer made purchases of an item consistently over a period of time prior to a time of the checkout;
in response to the step of determining that the customer made purchases of the item consistently over the period of time, the computer determining that the item is not included in the one or more items being purchased at the checkout;
the computer determining that no promotion is available for a purchase of the item at the time of the checkout;
the computer determining that one or more promotions were applied to the purchases of the item made by the customer over the period of time; and
based on the purchases of the item having been made consistently by the customer over the period of time, the item not being included in the one or more items being purchased at the checkout, no promotion being available for the purchase of the item at the time of the checkout, and the one or more promotions having been applied to the purchases of the item made by the customer over the period of time, the computer dynamically generating the promotion at the checkout for a purchase of the item in the current transaction, future transaction(s), or the current and future transaction(s), the promotion being generated at the checkout for use by the customer and not for use by any other customer.

2. The method of claim 1, further comprising the step of the computer adding the item to an order that includes the one or more items being purchased by the customer, wherein the step of dynamically generating the promotion is performed prior to a confirmation of the order.

3. The method of claim 1, further comprising the steps of:
the computer receiving a selection by the customer for the purchase of the item to occur in the current transaction; and
the computer applying the promotion to the purchase of the item in the current transaction.

4. The method of claim 1, further comprising the steps of:
the computer receiving a selection by the customer for the purchase of the item to occur in the future transaction(s) which are subsequent to a completion of the current transaction; and
the computer applying the promotion to the purchase of the item in the future transaction(s).

5. The method of claim 1, further comprising the step of the computer receiving a message from the customer that indicates the customer is not purchasing the item at the checkout because no promotion is available for the purchase of the item at the time of the checkout, wherein the step of dynamically generating the promotion is performed based in part on the message from the customer being received.

6. The method of claim 1, wherein the step of dynamically generating the promotion includes generating the promotion as a discount on a price of the item, wherein the discount is (i) based on a total monetary value of an order of the customer at the checkout exceeding a threshold value, (ii) permitted to be used within a predetermined period of time, (iii) permitted to be used exclusive of any other promotion relative to the item, (iv) available to the customer if the customer purchases a predetermined item; or (v) available to the customer if the customer purchases an item of a predetermined type.

7. The method of claim 6, further comprising the step of the computer determining a profit margin of the item, wherein the step of dynamically generating the promotion and the combination of the steps is based in part on the profit margin.

8. The method of claim 1, further comprising the step of:
providing at least one support service for at least one of creating, integrating, hosting, maintaining, and deploying computer-readable program code in the computer, the program code being executed by a processor of the computer to implement the steps of retrieving the purchase history, determining that the customer made the purchases of the item consistently over the period of time, determining that the item is not included in the one or more items being purchased at the checkout, determining that no promotion is available for the purchase of the item, determining that the one or more promotions were applied to the purchases of the item made by the customer over the period of time, and dynamically generating the promotion at the checkout for the purchase of the item.

9. A computer program product, comprising:
a computer-readable storage device; and
a computer-readable program code stored in the computer-readable storage device, the computer-readable program code containing instructions that are executed by a central processing unit (CPU) of a computer system to implement a method of generating a promotion at a checkout, the method comprising the steps of:
the computer system retrieving a purchase history of a customer who is purchasing one or more items at the checkout in a current transaction;
based on the retrieved purchase history, the computer system determining that the customer made purchases of an item consistently over a period of time prior to a time of the checkout;
in response to the step of determining that the customer made purchases of the item consistently over the period of time, the computer system determining that the item is not included in the one or more items being purchased at the checkout;
the computer system determining that no promotion is available for a purchase of the item at the time of the checkout;
the computer system determining that one or more promotions were applied to the purchases of the item made by the customer over the period of time; and
based on the purchases of the item having been made consistently by the customer over the period of time, the item not being included in the one or more items being purchased at the checkout, no promotion being available for the purchase of the item at the time of the checkout, and the one or more promotions having been applied to the purchases of the item made by the customer over the period of time, the computer system dynamically generating the promotion at the checkout for a purchase of the item in the current transaction, future transaction(s), or the current and future transaction(s), the promotion being generated at the checkout for use by the customer and not for use by any other customer.

10. The computer program product of claim 9, wherein the method further comprises the step of the computer system adding the item to an order that includes the one or more items being purchased by the customer, wherein the step of dynamically generating the promotion is performed prior to a confirmation of the order.

11. The computer program product of claim 9, wherein the method further comprises the steps of:
the computer system receiving a selection by the customer for the purchase of the item to occur in the current transaction; and
the computer system applying the promotion to the purchase of the item in the current transaction.

12. The computer program product of claim 9, wherein the method further comprises the steps of:
the computer system receiving a selection by the customer for the purchase of the item to occur in the future transaction(s) which are subsequent to a completion of the current transaction; and
the computer system applying the promotion to the purchase of the item in the future transaction(s).

13. The computer program product of claim 9, wherein the method further comprises the step of the computer system receiving a message from the customer that indicates the customer is not purchasing the item at the checkout because no promotion is available for the purchase of the item at the time of the checkout, wherein the step of dynamically generating the promotion is performed based in part on the message from the customer being received.

14. The computer program product of claim 9, wherein the step of dynamically generating the promotion includes generating the promotion as a discount on a price of the item, wherein the discount is (i) based on a total monetary value of an order of the customer at the checkout exceeding a threshold value, (ii) permitted to be used within a predetermined period of time, (iii) permitted to be used exclusive of any other promotion relative to the item, (iv) available to the customer if the customer purchases a predetermined item; or (v) available to the customer if the customer purchases an item of a predetermined type.

15. The computer program product of claim 14, wherein the method further comprises the step of the computer system determining a profit margin of the item, wherein the step of dynamically generating the promotion and the combination of the steps is based in part on the profit margin.

16. A computer system comprising:
a central processing unit (CPU);
a memory coupled to the CPU; and
a computer readable storage device coupled to the CPU, the storage device containing instructions that are executed by the CPU via the memory to implement a method of generating a promotion at a checkout, the method comprising the steps of:
the computer system retrieving a purchase history of a customer who is purchasing one or more items at the checkout in a current transaction;
based on the retrieved purchase history, the computer system determining that the customer made purchases of an item consistently over a period of time prior to a time of the checkout;
in response to the step of determining that the customer made purchases of the item consistently over the period of time, the computer system determining that the item is not included in the one or more items being purchased at the checkout;
the computer system determining that no promotion is available for a purchase of the item at the time of the checkout;
the computer system determining that one or more promotions were applied to the purchases of the item made by the customer over the period of time; and
based on the purchases of the item having been made consistently by the customer over the period of time, the item not being included in the one or more items being purchased at the checkout, no promotion being available for the purchase of the item at the time of the checkout, and the one or more promotions having been applied to the purchases of the item made by the customer over the period of time, the computer system dynamically generating the promotion at the checkout for a purchase of the item in the current transaction, future transaction(s), or the current and future transaction(s), the promotion being generated at the checkout for use by the customer and not for use by any other customer.

17. The computer system of claim 16, wherein the method further comprises the step of the computer system adding the item to an order that includes the one or more items being purchased by the customer, wherein the step of dynamically generating the promotion is performed prior to a confirmation of the order.

18. The computer system of claim 16, wherein the method further comprises the steps of:
the computer system receiving a selection by the customer for the purchase of the item to occur in the current transaction; and
the computer system applying the promotion to the purchase of the item in the current transaction.

19. The computer system of claim 16, wherein the method further comprises the steps of:
the computer system receiving a selection by the customer for the purchase of the item to occur in the future transaction(s) which are subsequent to a completion of the current transaction; and
the computer system applying the promotion to the purchase of the item in the future transaction(s).

20. The computer system of claim 16, wherein the method further comprises the step of the computer system receiving a message from the customer that indicates the customer is not purchasing the item at the checkout because no promotion is available for the purchase of the item at the time of the checkout, wherein the step of dynamically generating the promotion is performed based in part on the message from the customer being received.
